(19) United States
(12) Patent Application Publication
(10) Pub. No.: US 2009/0162176 A1
(43) Pub. Date: Jun. 25, 2009

(54) Stacker crane and method for operating a stacker crane

(76) Inventors: Ralf Link, Bietigheim-Bissingen (DE); Peter Lambeck, Stuttgart (DE); Bernhard Breitenbach, Stuttgart (DE)

Correspondence Address: FLYNN THIEL BOUTELL & TANIS, P.C., 2026 RAMBLING ROAD, KALAMAZOO, MI, 49008-1631, US

(21) Appl. No.: 12/315,106

(22) Filed: Nov. 26, 2008

(30) Foreign Application Priority Data
Dec. 21, 2007 (DE) 10 2007 063 553.4

(51) Int. Cl. B66F 9/02; B66F 9/18

(52) U.S. Cl. 414/659; 414/814

(57) ABSTRACT

The invention relates to a stacker crane (10) having at least one mast (12), a lift truck (14) movable along mast (12) and a load lifting means (16), located on lift truck (14), for moving a storage object (34) substantially perpendicular to mast (12).

According to the invention the stacker crane (10) has at least one device (38, 40) for detecting a position of the storage object (34) in bay (48) during the supply of storage object (34) from load lifting means (16) to a storage location in bay (48).

The invention relates to a stacker crane having at least one mast, a lift truck movable along the mast and a load lifting means, located on the lift truck, for moving a storage object substantially perpendicular to the mast. The invention also relates to a method for operating such a stacker crane.

Stacker cranes are e.g. known from EP 564 430 A1, in which a lift truck displaceably located on a mast and a load lifting means fixed to the lift truck are described. By means of such stacker cranes a storage object is supplied to a storage location, removed from said storage location and/or transported backwards and forwards between the storage location and an entrance/exit point. The storage location is e.g. provided in a high bay warehouse. For overcoming the height differences between the entrance/exit point and the storage location the lift truck is provided. The load lifting means supplies the storage object to the storage location, e.g. on reaching the latter. To ensure that the storage object has been completely introduced into the area of the storage location, in the case of known stacker cranes the storage object is brought with the load lifting means up to an end stop in the storage location. However, the striking of the storage object against the end stop imposes high stresses on the stacker crane and in particular the load lifting means. As, in addition, a slip on the load lifting means on transporting the storage object into the area of the storage location cannot be excluded with the known stacker cranes, it is also impossible to ensure that the storage object has been introduced far enough into the area of the storage location.

Therefore the problem of the invention is to provide a stacker crane by means of which a storage object can be reliably supplied to a storage location, without the stacker crane being exposed to unnecessary mechanical and/or electrical stresses.

This problem is solved by an inventive stacker crane having the features of claim 1 and by an inventive method having the features of claim 11. Some of the following, but not exhaustively enumerated features and characteristics apply both to the stacker crane and to the method. In part they are only described once, but independently of one another and in random combination apply both to the stacker crane and to the method. Moreover the sequence of the listed features is not binding and can instead be modified corresponding to an optimized stacker crane or optimized method. Individual features of the different embodiments described and shown can be combined in a random manner without passing beyond the scope of the invention.

According to the invention in the case of a stacker crane having at least one mast, a lift truck displaceable along the mast and a load lifting means, located on the lift truck, for moving at least one storage object substantially perpendicular to the mast, the stacker crane has at least one device for detecting a position of the storage object in the bay during the supply of the storage object by the load lifting means to a storage location in the bay and vice versa.

Thus, the storage object can be transported in controlled manner e.g. to a predefined point of a storage location. It is important in the case of the invention that a position of the storage object in the bay is detected during the loading process, e.g. in a continuous manner. Thus, the position of the storage object during loading is always known and the load lifting means can operate without slip and without end stops in the bay. The detection of the storage object position takes place during loading into the bay and also on removing from the bay. The transportation of the storage object perpendicular to the lift truck mast by the load lifting means, e.g. into the storage location of a multistorey garage, can e.g. take place by means of a so-called belt tension conveyor, by means of fork arms, a table or the like and through the detection of the actual position of the storage object any slip which occurs can be taken into account. According to the invention slip means the behaviour of a technical element, which e.g. in synchronized manner with a clearly defined speed ratio with respect to another rotating element is intended to jointly rotate, but where the speed differs from said defined ratio. The inventive stacker crane is e.g. used in so-called lanes between two storage areas constructed in bay form. In order to be able to move along such lanes, rail-like devices or the like are provided for the stacker crane and are e.g. located on the floor and on the ceiling in the vicinity of the lane parallel to the path of the high bays or parallel to the path of the lane. By means of corresponding devices, particularly in the end regions of the stacker crane mast, the stacker crane is then made to engage with such rails.

The lift truck can bring about a vertical transporting movement of the load lifting means and therefore also the storage object. The lift truck can be adjusted in its vertical position for this purpose e.g. by means of a reversed cable or the like, which together with a drive forms a lifting gear.

The device for detecting the position of a storage object can be a substantially randomly constructed sensor or a substantially randomly constructed sensor arrangement. In the sense of the invention it can be adequate if the sensor only detects the presence or absence of a storage object at a specific position. This can take place using corresponding devices, e.g. magnets, reflectors, RFID chips, etc., particularly on the storage object and/or on a pallet serving as a base for the storage object. However, it is advantageous to detect at least two positions of the storage object in the bay, e.g. end positions at the first, second, third or fourth storage location in the case of a quadruple depth loading. In particular, there can be a continuous detection of the storage object position during the loading and/or removal process.

In a development of the invention at least part of the device for detecting the position is located on the load lifting means.

The sensor can e.g. be positioned in such a way that the storage object to be transported both during taking up and on depositing is moved past the device. If the sensor is e.g. constructed as a light barrier or the like, in the case of a corresponding arrangement of the sensor it is possible to detect whether the storage object is still in the area of the sensor or has left said area.

In a development of the invention the device for detecting the position is placed on a frame at least sectorwise surrounding the load lifting means.

The frame can e.g. comprise industrial profiles or sections, which are manufactured as continuously cast aluminium sections. It then serves firstly as a type of protective device for the storage object during the positioning of the latter on the load lifting means and secondly the frame provides a number of possibilities for receiving the most varied sensors, e.g. for the weight and/or identity of the storage object or the like, in addition to the position detection sensor. It is also possible within the scope of the invention to provide on the frame at least sectorwise surrounding the load lifting means sensors for detecting an outer contour of the storage object, so that in this way it is possible to establish the total size or volume, or also only the maximum height extension, etc.

According to a development of the invention at least part of the position detection device is located on the lift truck. Alternatively at least a part of the device for detecting the position can be located on the mast. What is essential to the invention is the storage object position detection perpendicular to the mast. This can e.g. be a spacing or distance of the storage object from an imaginary axis of the storage lane, a spacing or distance from the mast, the lift truck or the load lifting means. Thus, sensors for detecting a storage object position can be located on the mast, lift truck and/or load lifting means.

In a further development of the invention the device for detecting the position is a light barrier, a proximity switch, at least one camera and/or at least one CCD array.

A light barrier used can have a random construction, e.g. as a light barrier where the transmitter and receiver are placed in a common housing and the transmitter emits a light beam onto a reflector device. The light barrier could also be constructed with transmitting and receiver housed in different housings. It is finally possible to use a so-called light curtain and/or a device, which e.g. functions in the same way as a laser range finder.

A proximity switch, such as can be used as the sensor, can e.g. be a capacitive or inductive switch. It is also obviously possible to use an electromechanical switch, which contacts the storage object for detection purposes.

A camera provided for position detection purposes is preferably provided with a corresponding control device in which can be implemented a corresponding software for evaluating a camera output signal. Such a software can e.g. incorporate an image identification software.

Such a camera can also have a CCD array or the like, i.e. a so-called digital camera. According to the invention it is also possible for the CCD array to only be a line array, which then carries out the inventive position detection like a light curtain, etc.

In a development of the invention the at least one storage object position detection device is constructed and positioned for detecting the storage object position in an area of the outer edge of a bay facing the mast.

In this way it can advantageously be ensured that a storage object stored in the bay does not project over said outer edge. Thus, parts of the stacker crane can extend close to the edge or the lane can be kept relatively narrow without colliding with the stacker crane or parts thereof, e.g. during movement in the lane with already stored storage objects.

In a development of the invention the stacker crane has at least one control device for evaluating an output signal, etc. of the detection device.

Such a control device can e.g. have a microprocessor, a programmable logic control (PLC), a relay circuit, etc. The control device is preferably constructed so as to be able to implement therein a corresponding control software.

The problem of the invention is also solved with a method for operating a stacker crane having at least one mast, a lift truck displaceable along the mast and a load lifting means, placed on the lift truck, for moving at least one storage object substantially perpendicular to the mast, the method involving the steps of positioning a load lifting means in the vicinity of a storage location for the storage object, moving the storage object substantially perpendicular to the mast and detecting at least one position of a storage object in the bay during the supply of the storage object from the load lifting means to a storage location in the bay or vice versa.

Advantageously the position of the storage object in the bay is detected at at least two bay points or continuously during loading and removal.

In a development of the invention the method comprises the step of detecting an end position of the storage object relative to the lift truck, the mast and/or the load lifting means.

In a further development of the invention the method comprises the step of detecting the position by means of at least one light barrier, a proximity switch, at least one camera and/or at least one CCD array.

In a further development of the invention the end position of the storage object is detected as being reached by means of a control device when the storage object has a predefined spacing from the lift truck, mast and/or a predefined spacing relative to a defined point on the load lifting means.

Further advantages and features of the invention can be gathered from the claims and the following description of embodiments illustrated by means of the drawings. In part, features of the embodiments are only described relative to one representation of an embodiment, but within the scope of the invention can be randomly combined with other embodiments. In the diagrammatic drawings show:

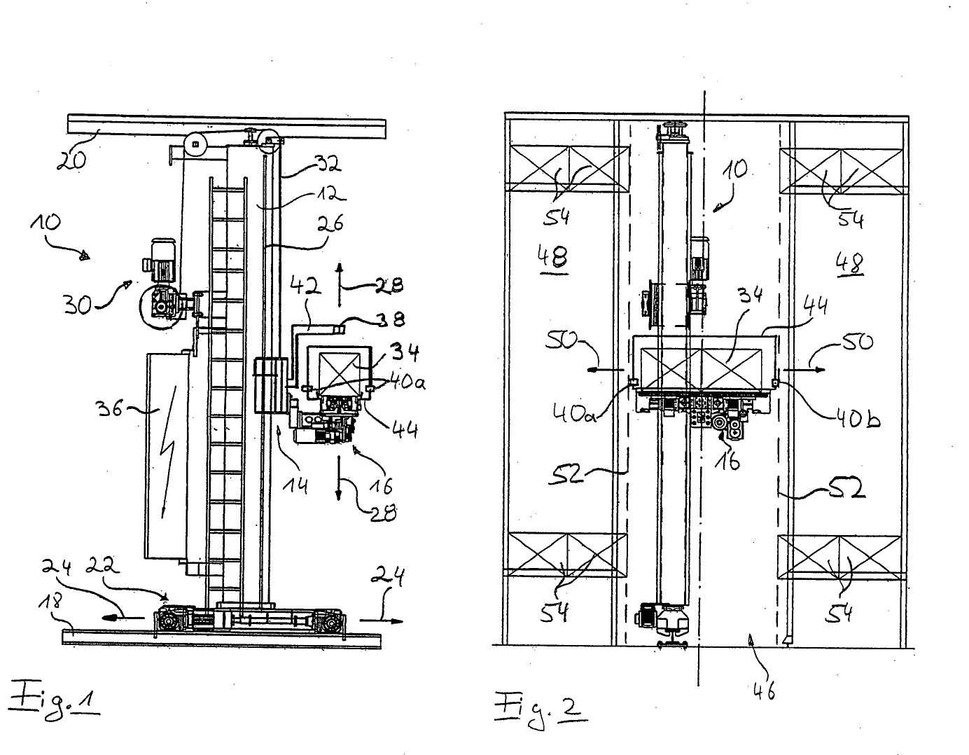

FIG. 1 A side view of an inventive stacker crane with different possibilities for the arrangement of inventive sensors.

FIG. 2 The inventive stacker crane of FIG. 1 in a lane between two storage bays provided for the stacker crane.

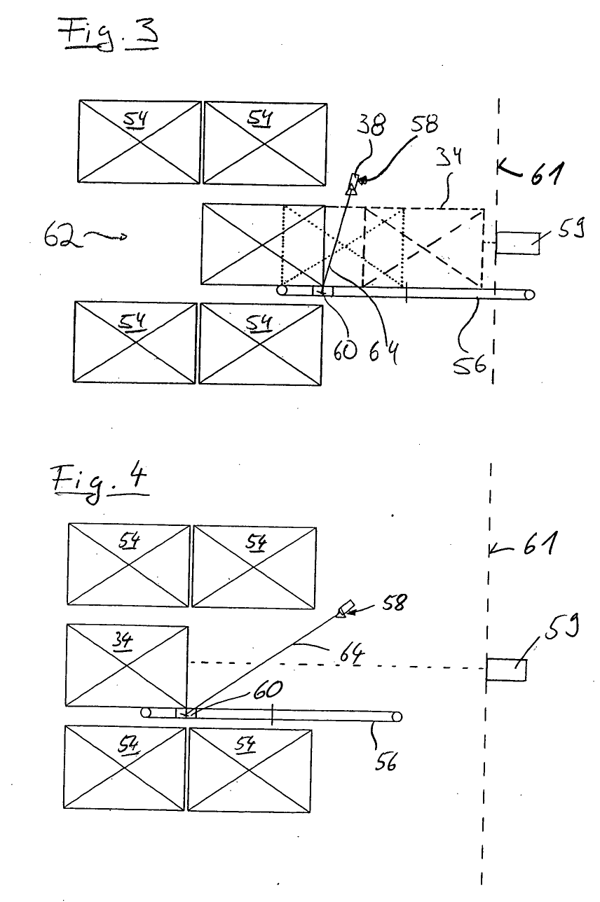

FIGS. 3 Representations of the operation of the inventive stacker and 4 crane according to a further embodiment.

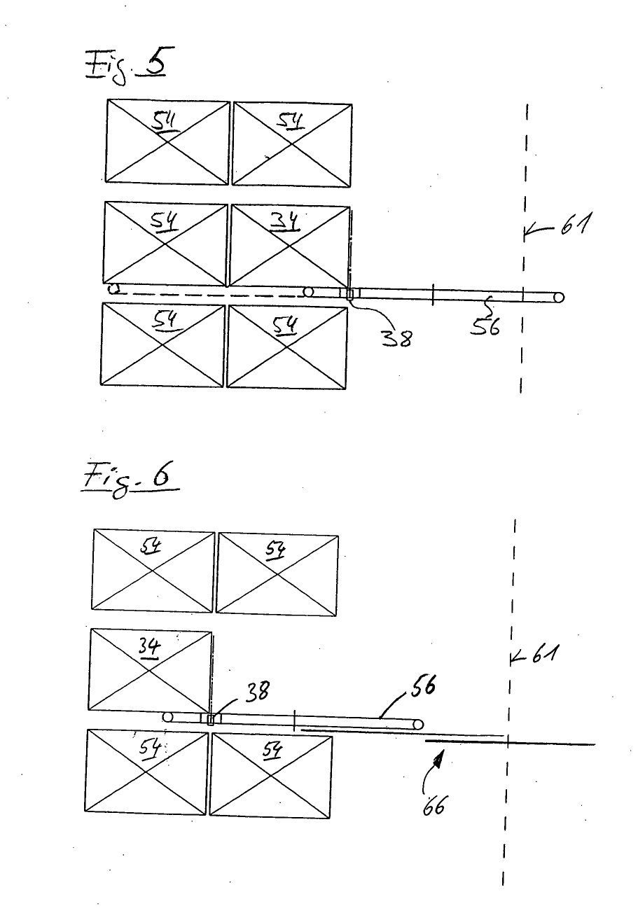

FIGS. 5 Representations of the operation of the stacker crane and 6 according to the invention in a further embodiment.

The stacker crane 10 diagrammatically illustrated in FIG. 1 has a mast 12, a lift truck 14 and a load lifting means 16. Mast 12 is positioned between a floor-side track 18 and a ceiling-side guide rail 20 and has corresponding drive devices 22 cooperating with the rails in order to allow a movement of the stacker crane 10 in the direction of arrows 24. Arrows 24 point in the longitudinal direction of a lane not shown in FIG. 1 and in which the stacker crane is positioned.

The lift truck 14 is connected to mast 12 by means of a linear guide 26, so that the lift truck 14 can be moved ceilingwards or floorwards in the direction of arrows 28. Arrows 28 point in the up and down direction of the lane not illustrated in FIG. 1 and in which the stacker crane is located. For driving the lift truck 14 a lifting gear 30 is provided, which drives the lift truck 14 ceilingwards or floorwards by means of a cable 32 and which is guided via return pulleys in the ceiling-near end region of mast 12.

On lift truck 14 is provided a load lifting means 16 with which it is possible to transport a storage object 34 or several storage objects 34.

On the stacker crane 10 is also provided a switch cabinet 36 containing the necessary electronic and/or electrical control means for the stacker crane 10.

In order to detect a position of storage object 34, sensors 38, 40 are provided on stacker crane 10. Sensor 38 is placed on an arm 42 fixed to the lift truck 14. However, sensor 40a is placed on a frame 44, which surrounds the storage object 34 and is part of the load lifting means 16. The arrangement of the sensors 38, 40a on arm 42 and frame 44 can be implemented in alternative or joint manner.

The sensor 38 shown in FIG. 1 is a reflection light barrier. Reflection light barriers generally have in a common housing a light transmitter and a light receiver. Light emitted by the light transmitter is reflected by a surface irradiated by the light and the reflected light is detected by the light receiver. The area in which the irradiated and reflected light beam moves in such a way that the light receiver can receive the reflected light beam is the sensor area of the sensor 38. The light barrier can detect differences in the reflection behaviour of the irradiated surface, so that it is possible to detect the presence of a storage object 34 to be stored on load lifting means 16. According to FIG. 1 sensor 38 is positioned above the load lifting means 16 and the sensor area of sensor 38 is so oriented that it is possible to detect the presence of part of a storage object 34 on the lane side of an outer edge 52 of bay 48 illustrated in FIG. 2.

Sensor 40a is a so-called, not further illustrated one-way light barrier. In one-way light barriers the light transmitter and light receiver are placed in separate housings facing one another. The light transmitter and light receiver are so mutually oriented that light irradiated by the light transmitter can be detected by the light receiver. The sensor area of such a sensor between the light transmitter and light receiver is exactly the area of the light beam passing between them. As can be gathered from FIG. 1 in conjunction with FIG. 2, the sensor 40 is located in a bay-side end region of frame 44, adjacent to the outer edge 52 shown in FIG. 2. If from load lifting means 16 a storage object 34 to be loaded is supplied to a storage location, the storage object 34 traverses the sensor area of sensor 4 and consequently interrupts the light beam. As soon as the storage object 34 has left the sensor area, the preset position of the storage object 34 in the bay is reached, namely in such a way that the storage object 34 does not project beyond the outer edge 52 of bay 48 in FIG. 2.

In FIG. 2 the inventive stacker crane 10 is located in a so-called lane 46 formed between two storage bays 48. The load lifting means 16 of stacker crane 10 has a not shown drive in order to supply storage object 34 to the storage bays 48 on one or both sides of the stacker crane 10 or remove the said storage object 34 from the bays 48. Loading and removal take place in the direction of arrows 50.

FIG. 2 shows that the sensors 40a, 40b are located on frame 44, namely on both sides of the load lifting means 16 in arrow direction 50. Obviously it is possible to position the sensors 40a, 40b or the devices for detecting the position of a storage object 34 at a random different position of frame 44.

A sensor 40a, 40b can e.g. also be a not shown light barrier, a not shown camera, which can be both analog and digital, and finally a randomly constructed proximity switch not shown in FIG. 2.

FIG. 2 also shows the outer edges 52 of bays 48 beyond which a loaded storage object 54 must not project in the direction of the stacker crane 10 or in directions of a median plane of the lane 46 projecting parallel to the longitudinal path of the lane 46. Otherwise the load lifting means 16 and/or frame 44 and/or further parts of the stacker crane 10 could collide with the stored or loaded storage object 54.

The belt tension conveyor 56 shown in FIG. 3 is part of the load lifting means of the inventive stacker crane, which is not shown in FIG. 3 so as not to overburden representation. However, FIG. 3 does show already loaded and correctly positioned storage objects 54 and also a storage object 34 which is still to be loaded and which is shown in different positions relative to a storage location. FIG. 3 also shows an exemplified device 38 for detecting the position of a storage object 34, which is here constructed as a reflection light barrier with a transmitter-receiver unit 58 and a reflector 60. The transmitter-receiver unit 58 is e.g. located on a frame on the lift truck and therefore is constantly spaced with respect to a mast 61 represented in broken line form. Reflector 60 is located on the belt tension conveyor 56 and is moved together therewith towards the bay or away from the bay again. The belt tension conveyor 56 is placed on a not shown telescopic table and can therefore be moved into and out of the bay.

If the storage object 34 to be loaded is supplied to the area 62 of the storage location provided for the storage object 34, the latter is outside the storage bay not shown in FIG. 3, but whose position is made apparent by the loaded storage objects 54 shown. This first position of the storage object 34 still to be loaded is shown in broken line form in FIG. 3 and it is clear that the storage object 34 does not extend into a sensor area 64 of device 38.

If the storage object 34 to be loaded is moved by means of the belt tension conveyor 56 into the bay not shown in FIG. 3, the storage objects 34 successively assume the first, broken line position, a second dotted line position and a third continuous line position. FIG. 3 shows that the second position shown in dotted line form allows the detection of the storage object 34. If the storage object 34 is transported from the dotted line position into the third position shown in continuous line form, the storage object 34 once again leaves the sensor area 64 of device 38. Through corresponding setting up or orientation of the sensor area 64 it is possible to position the storage object 34 to be loaded flush with a defined edge and in the present case flush with the outer edge 52 of storage bay 48 shown in FIG. 2.

FIG. 4 shows the belt tension conveyor 56 of FIG. 3 during the loading of a storage object 34 into a second bay location, which is removed from mast 64 by somewhat more than the length of the storage object 34 than the first storage location onto which the storage object 34 was moved in FIG. 3. The bay is constructed with double depth relative to the depth of the storage object 34 or the already loaded storage objects 54. The description is obviously solely of an exemplified nature and the inventive stacker crane can also be used for loading in quadruple depth bays.

In order to reach the rear bay location, the belt tension conveyor 56 is moved on the not shown telescopic table away from the mast 61 by roughly the depth of storage object 34 and further than in the case of FIG. 3. The position of the belt tension conveyor 56 or the complete load lifting means with conveyor 56 and telescopic table is always precisely known, because for this purpose e.g. rotation angle sensors are provided or the length of a discharge or extension of the telescopic table and the exact position of the load lifting means on mast 61 are continuously exactly established. Thus, the exact position of reflector 60 is also known and said reflector 60 is moved so far from mast 61 into the bay until it is located in the position shown in FIG. 4, i.e. level with the leading edge of the rear bay location. The belt tension conveyor 56 is now operated until the transmitter-receiver unit 58 again receives a light signal from reflector 60, i.e. the storage object 34 has left the sensor area 64. In this position of the storage object 34 the latter is precisely in the intended position, corresponding to the rear bay location, and the belt tension conveyor 56 can be switched off. Subsequently the telescopic table together with the belt tension conveyor 56 can be retracted until the latter is again freely movable through the storage lane.

The transmitter-receiver unit 58 can be fixed in rotary manner to the lift truck so as to be always exactly oriented onto the reflector 60. If a spacing sensor 59 is provided on mast 61 and directed onto the front side of the storage object 34 facing the storage bay, its position can be continuously determined throughout the loading process and also during removal.

FIG. 5 shows another embodiment of an inventive stacker crane in which the device 38 has a proximity switch. The proximity switch 38 can establish whether or not a storage object 34 is in position on the belt tension conveyor 56.

FIG. 4 shows already loaded storage objects 54, to which has been added a newly loaded storage object 34. Storage object 34 has been loaded with the belt tension conveyor 56. In accordance with FIG. 4 the proximity sensor is so oriented that the storage object 34 is positioned flush with the defined leading edge of the bay.

The position of the belt tension conveyor 56 and therefore also the position of the proximity sensor of device 38 is accurately known. The belt tension conveyor 56 is extended by means of the not shown telescopic table in the direction of the bay to such an extent that the proximity sensor is exactly level with the leading edge of the bay. The belt tension conveyor 56 is then put into operation and the storage object 34 is moved into the bay until its leading edge is flush with the leading edge of the bay.

FIG. 6 shows the stacker crane according to FIG. 5 on loading a storage object 34 into a rear bay location. The proximity sensor on device 38 is extended together with the belt tension conveyor 56 over the diagrammatically represented telescopic table 66 to such an extent that it is precisely located on the leading edge of the rear bay location. The belt tension conveyor 56 is then put into operation until the leading edge of the storage object 34 is precisely aligned with the leading edge of the rear bay location, as shown in FIG. 6. As the position of the proximity sensor and in particular its distance from the mast 61 is precisely known, in the position of the storage object 34 shown in FIG. 6 it can be precisely established that the storage object 34 is located on the rear bay location. The load lifting means with the belt tension conveyor 56 and telescopic table 66 can then be retracted.

By means of the proximity sensor on device 38 it is also possible to accurately establish on removing storage objects 34, 54 from the bay where the leading edge of the storage object 34 is located and the belt tension conveyor 56 can be moved into the position necessary for removal.

Thus, the invention makes it possible to detect a storage object position during loading and removal in the bay. It is e.g. possible to detect solely the reaching of a single, predefined position, e.g. the exact position of a leading edge of the storage object relative to the bay, as well as detect several positions of the storage object, whilst also permitting a continuous detection of the position of the storage object 34 in the bay during loading and removal.

1. Stacker crane with at least one mast (12), a lift truck (14) displaceable along the mast (12) and a load lifting means (16), located on the lift truck (14), for moving at least one storage object (34) substantially perpendicular to the mast (12), characterized in that the stacker crane (10) has at least one device (38, 40) for detecting a position of a storage object (34) in bay (48) during the supply of storage object (34) by the load lifting means (16) to a storage location in bay (48) and vice versa.

2. Stacker crane according to claim 1, characterized in that a position of the storage object (34) in bay (48) is continuously detected during the loading or removal of storage object (34).

3. Stacker crane according to claim 1, characterized in that a position of the storage object (34) in bay (48) is detected at at least two bay points during the loading or removal of storage object (34).

4. Stacker crane according to claim 1, characterized in that at least part of the position detection device (38, 40) is located on load lifting means (16).

5. Stacker crane according to claim 1, characterized in that the position detection device (38, 40) is located on a frame (44) at least sectorwise surrounding the load lifting means (16).

6. Stacker crane according to claim 1, characterized in that at least part of the position detection device (38, 40) is located on lift truck (16).

7. Stacker crane according to claim 1, characterized in that at least part of the position detection device (38, 40) is located on mast (12).

8. Stacker crane according to claim 1, characterized in that the position detection device (38, 40) is a light barrier, a proximity switch, at least one camera and/or at least one CCD array.

9. Stacker crane according to claim 1, characterized in that the at least one device (38, 40) is constructed and positioned for detecting the position of the storage object (34), so as to detect the position of said storage object (34) in an area of an outer edge (52) of a bay (48) facing the mast (12).

10. Stacker crane according to claim 1, characterized in that the stacker crane (10) has at least one control device for evaluating an output signal or the like of the detection device (38, 40).

11. Method for operating a stacker crane (10) having at least one mast (12), a lift truck (14) displaceable along mast (12) and a load lifting means (16), located on lift truck (14), for moving at least one storage object (34) substantially perpendicular to the mast (12) according to claim 1, characterized by the steps of:
positioning a load lifting means (16) in the vicinity of a storage location (62) for storage object (34),
moving the storage object (34) substantially perpendicular to mast (12) and
detecting at least one position of a storage object (34) in bay (48) during the supply of storage object (34) from load lifting means (16) to a storage location in bay (48) and vice versa.

12. Method according to claim 11, characterized by the continuous detection of a position of storage object (34) in bay (48) during the loading and removal of storage object (34).

13. Method according to claim 11, characterized by detecting a position of the storage object (34) in bay (48) at at least two bay positions during storage object loading and removal.

14. Method according to claim 11, characterized by detecting an end position of storage object (34) relative to lift truck (14), mast (12) and/or load lifting means (16).

15. Method according to claim 11, characterized in that the end position of the storage object (34) is detected as reached by means of a control device if the storage object (34) has a predefined spacing from the lift truck (14), mast (12) and/or relative to a defined point on the load lifting means (16).
